(19) United States
(12) Patent Application Publication
(10) Pub. No.: US 2011/0039521 A1
(43) Pub. Date: Feb. 17, 2011

(54) Method for call waiting feature #2

(76) Inventor: Todd Russell Ustby, Rochester, MN (US)

Correspondence Address: Todd R. Ustby, 1211 Ashley Ln SW, Rochester, MN, 55902, US

(21) Appl. No.: 12/462,889

(22) Filed: Aug. 11, 2009

(51) Int. Cl. H04M 3/42

(52) U.S. Cl. 455/414.1

(57) ABSTRACT

An improved call waiting feature #2 process is provided wherein the called party (user) may elect to send an immediate SMS text message to the calling party just by pressing one button on the user's cell phone. This message can be a default message, or a personalized on based on the phone number calling into the user's phone. By doing this, the user has acknowledged the callers call, and the caller now just waits for the user to call back.

### BACKGROUND OF THE INVENTION

The present invention relates to an improved method for handling incoming calls when the party being called is unable to answer the phone.

### DESCRIPTION OF THE PRIOR ART

“Call waiting” is a feature that has been offered by the providers of telephone communication services for quite some time. In its most basic form, call waiting involves sending an audible signal to a party engaged in a phone call (the “user”) when the user receives a second, incoming call. Upon receipt of such a signal, the user has the option to either elect to take the second call and place the first caller on hold by pressing a button on the user's phone or to ignore the second call, in which case the second caller receives a busy signal or is transferred to a voice message system in which the second caller is informed that the user is unable to take his/her call and invited to leave a message on a recording.

There are a number of variations on the basic call waiting feature. These variations generally fall into one or both of two types of processes. In one, the user is provided with various disposition options to which he/she can direct the second call. In the other, information is provided to the user concerning the identity of the second caller so that the user (or the phone system) can determine how to handle the second call (i.e., accept it, reject it, send it to one of a number of different disposition options).

There are also variations in handling calls when the user is not on the phone. In the most common instance, the person being called, can simply not answer the phone and let it go to voice mail. In other cases, the user can press ignore, and the call goes immediately to voice mail. In either case, the person calling the user, does not know if the user saw that they were calling them and the user can not acknowledge the call, to the caller without answering the phone.

The following patents are illustrative of the prior art.

In U.S. Pat. No. 4,661,975, a call waiting process is described wherein the user has the option to take the second call and place the first caller on hold (as in basic call waiting) or, by selecting various keys on his/her phone, to elect various other treatments of the second call, such as connecting the second call to a busy signal, connecting the second call to a pre-recorded message, or connecting the second call to another phone or calling station.

In U.S. Pat. No. 5,263,084, a call waiting process is described wherein information relating to the identification of the second caller is spontaneously transmitted to the user to allow the user to accept or reject the second call based on such information.

In U.S. Pat. No. 5,309,512, a call waiting process is described wherein, in addition to alerting the user of a second incoming call, the user is provided with information as to the origin of the second incoming call so that the user is better able to decide whether to accept or reject the second incoming call.

In U.S. Pat. No. 5,425,092, a call waiting process is described wherein information relating to the identification of the second caller is used by the phone system to determine whether or not a call waiting signal is transmitted to the user.

In U.S. Pat. No. 5,680,447, a call waiting process is described wherein the user has the option to take the second call and place the first caller on hold (as in basic call waiting) or, by selecting one of various keys on his/her phone, to connect the second caller to a variety of pre-recorded messages, the specific message depending upon the key that is selected by the user.

In U.S. Pat. No. 5,848,142, a call waiting process is described wherein, in addition to the basic options of accepting or rejecting the incoming call, the user is given the options of (1) rejecting the incoming call with a message to the second caller to call again after a pre-determined time, (2) rejecting the incoming call with a message to the second caller that the user will return the call after a pre-determined time, (3) conferencing the second call into the first call, (4) directing that the second call be transferred to another phone or voicemail, or (5) disabling the call waiting feature.

In U.S. Pat. No. 6,415,026, a call waiting process is described wherein information concerning the identity of the second caller is processed by the phone system to determine how the second call is processed, based on a number of parameters set by the user. If the second call does not correspond to any of the selected parameters, the second call is handled with basic call waiting. If the second call corresponds to any of the parameters, the system determines which of a number of options should be selected for that call.

In U.S. Pat. No. 6,954,521, a call waiting process is described wherein information concerning the identity of the second caller is provided to the user in audible form. The user then has the option to send the second call to a number of disposition options.

In U.S. Pat. No. 7,095,826, a call waiting process is described wherein the user is provided with recorded (audible) information concerning the identity of a second incoming caller when the first call is over.

In U.S. Pat. No. 7,099,452, a call waiting process is described wherein the second caller is provided with an option to either immediately send the user a call-waiting signal or to leave a message that is delivered to the user immediately after the first call is terminated.

In all the call waiting processes of the prior art, the user must initially make a selection between placing the first caller on hold while he/she answers the second call, or rejecting the second call by sending it to one or more disposal options. Having to reject one of the callers in favor of the other is not an optimal solution. On one hand, placing the first caller on hold while the user accepts the second call may be considered to be rude and indicates to the first caller that his/her call is not of primary importance to the user. On the other hand, rejecting the second call often causes the user to lose an opportunity to speak to the second caller, who either has to call the user back or leave a message and wait for the user to call him/her back. In many of these call back instances, one of the parties will have accepted another call or otherwise be unavailable when the return call is made.

Another problem with call waiting processes of the prior art is that, while the user is not on the phone, there is currently no way to immediately let the caller know, that you are busy and can't take their phone call, other than voice mail or answering the phone. Currently there is no process in which a user can send a SMS personalized text message, to the caller, while the caller is trying to reach the user, by pressing one button on the users phone.

### BRIEF SUMMARY OF THE INVENTION

It is one object of the present invention to provide an improved incoming call handling process where the user is not on the phone and sees the caller trying to reach the user and when the user cannot take the call, the user can press one button on his/her cell phone and a personalized text message is sent back to first caller without answering the incoming call. When the user presses one button, the user's cell phone can send out different messages, to the caller, based on the phone number that is calling the user. When the caller gets this returned SMS text message, while trying to reach the user, the caller sees that the user acknowledged their call and sees that the user is unavailable to take the call at this time.

### DESCRIPTION OF THE DRAWING

FIG. 1 is a flow chart showing the initial process for processing a phone call.

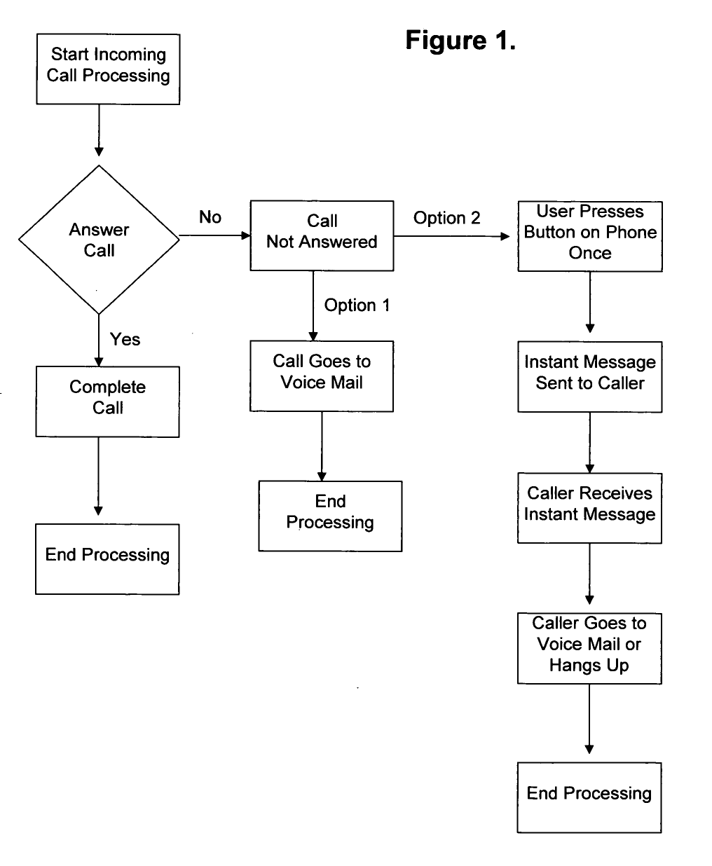

### DETAILED DESCRIPTION OF THE PREFERRED EMBODIMENT

The present invention involves an improved method of handling incoming calls, when the called party (“user”) can not take a call, such as the user is busy in a meeting and can not answer the new incoming call. It is believed that the equipment, circuitry and other mechanics for implementing the process are well known in the art and will not be discussed in any great detail here, the invention being the process and not the means by which it is implemented.

Referring to the drawing, wherein like numerals represent like elements throughout the several views, there is shown a flow chart illustrating the process of the present invention. The process is entered by an incoming call shown at step 101. In step 102, the user has the option to answer the phone or not. If the user elects to answer the phone, the user then completes the call in step 103, then in normal fashion, the call is ended.

In step 102, if the user elects not to answer the call, step 104 shows two options for the user. Option 1, is the most common method, in which the call goes to voice mail as shown in step 105. After complete of voice mail, the call is ended.

Option 2 is when the user elects to use the New Call Waiting Feature 2 process and presses one button on the phone, as shown in step 106. As shown in step 107, an instant message is sent to the caller. In step 108, the caller receives a preprogrammed, instant SMS message from the user. In step 109, the caller is then sent to voice mail and the process is terminated in the usual fashion.

What is claimed is:

1. An improved method of processing an incoming call while the user is not on the phone and unable to take the call. The claim is that this new process allows the user an option in which the user can press one button on his/her cell phone while the caller is calling the user, and an instant SMS text message is sent from the user's phone to the calling party. This message is also personalized and different messages can be sent to different callers, all based on the phone number the call is coming from and these different messages are sent by pressing the same button. An example is below.
(a) When someone is in a meeting, they can not always answer their phone. They can sometimes see who's calling them, because the light on the phone came on or the phone vibrated. Now with the “New Call Waiting Feature 2” program, all the user has to do is press one key on their phone and a personalized message is sent back to the caller. The message may read, “Hi John, thanks for calling. I'm in a meeting now, but I'll call you as soon as I get done. Thanks, Todd.” This program has preprogrammed messages, that when the user presses a key on their phone, a different message will be sent based on who's calling. If John calls the user, he'll get a different message than when Sara calls. If the caller's number is not preprogrammed into the users cell phone, a default message is sent out.
(b) When someone is driving down the road and it may be too dangerous to answer the phone or against the law to talk on the phone while driving. The called party the (user), can now hit one button on there phone in which a message is sent back immediately to the caller, saying they are unable to take their call at this time. The caller sees the message and waits for the user to call them back. If the user answers the phone or try's to text back to the caller, they risk possibly getting into an accident.
